(19) United States
(12) Patent Application Publication
(10) Pub. No.: US 2026/0187368 A1
(43) Pub. Date: Jul. 2, 2026

(54) RESPONSE LATENCY IN GENERATIVE MODELS

(71) Applicant: GOOGLE LLC, Mountain View, CA (US)

(72) Inventor: Clark Alan DuVall, Cupertino, CA (US)

(21) Appl. No.: 19/002,350

(22) Filed: Dec. 26, 2024

(51) Int. Cl. G06F 40/284; G06F 12/0855

(52) U.S. Cl. CPC G06F 40/284; G06F 12/0859; G06F 2212/1024

(57) ABSTRACT

Disclosed implementations use generative machine learning methods to generate an internal state based on content from a resource and provide responses to prompts based on the internal state. In an example implementation, content from a resource is converted to tokens based on a vocabulary associated with a task. A state for a generative model is generated by processing the tokens through the generative model. A prompt from a user interface and the prompt is processed through the generative model to generate a response based on the state. The response is provided to the user interface.

### BACKGROUND

Generative models use machine learning to discover patterns in data and generate new data. Latency refers to the time delay between when a generative model receives an input and generates the corresponding output.

### SUMMARY

Running generative models on user devices maintains privacy and greatly increases the features that users can launch while taking advantage of the local hardware and mitigating possible processor constraints (e.g., the limited memory of tensor processing units). At least one technical problem with the current approaches for running a generative model locally is that these models are computationally expensive and response time (the time between when a user requests a response from the model and when the model generates the response) is long. Slow model responses discourage use of the functions/services provided via the model.

The implementations described herein provide at least one technical solution to these technical problems by reducing latency for generative model responses by tokenizing and loading content into a model in a series of portions (e.g., sets of tokens), parallel weight loading, and/or model swapping. In some implementations, a model loads content, for example, while the page loads and/or while the user enters a prompt to be provided to the model. This preloading of content creates an internal state, or context, for a prompt related to the content. The model provides an answer based on the internal state once the prompt is received. This state can be saved and reloaded when, for example, the resource is visited again after the user navigates away from the resource. This preprocessing of the page content decreases the wait time between when a response is requested and when it is received.

In an example implementation, content from a resource is converted to tokens based on a vocabulary associated with a task. A state for a generative model is generated by processing the tokens through the generative model and storing the state to a cache. A prompt is received from a user interface. The prompt is processed through the generative model to generate a response. The response is provided to the user interface.

It is appreciated that methods in accordance with the present disclosure can include any combination of the aspects and features described herein. That is, methods in accordance with the present disclosure are not limited to the combinations of aspects and features specifically described herein, but also may include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

FIGS. 1A and 1B each depict an example system for background context processing based on content provided via a resource to reduce model latency performed by implementations of the present disclosure.

FIG. 2 depicts an example system for prompt prefix caching latency performed by implementations of the present disclosure.

FIG. 3 depicts an example system for dynamically swapping a Low-Rank Adaptation (LoRA) model performed by implementations of the present disclosure.

FIG. 4 depicts an example of a system 400 for parallel weight loading of a generative model performed by implementations of the present disclosure.

FIG. 5 depicts an example architecture that can be employed to execute implementations of the present disclosure.

FIG. 6 depicts a flowchart of a non-limiting process that can be performed by implementations of the present disclosure.

FIG. 7 is a diagram that illustrates an example of a distributed computer device that can be used to implement the described techniques.

### DETAILED DESCRIPTION

Generative models are trained to produce text, images, videos, or other forms of data. These models learn the underlying patterns and structures of their training data and use them to produce new data based on input, which often comes in the form of natural language prompts, and prompt context. Generative models can be executed via a server. The server is configured to provide prompts received from client devices to the models as input and to provide the output from the model as a response to the prompt. Such server-based execution provides the necessary processing power and allows for increased scalability for large models. With the ever-expanding processing power of user devices, local execution of smaller generative models has become more commonplace as the execution of generative models has become less computationally expensive. When a generative model “executes locally,” the model runs directly on a user device and processes information without requiring communication to a remote server. Running generative models locally maintains privacy and increases the features that users may launch while taking advantage of the local hardware (i.e., leveraging local memory) and mitigating possible processor constraints (e.g., the limited memory of tensor processing units).

At least one technical problem with current approaches for executing a generative model locally via a user device is that these models are computationally expensive and response time (i.e., the time between when a user requests a response from the model and when the model generates the response) is long. Slow model responses discourage use of the features provided via the model. Moreover, standard approaches reprocess the prompt each time a new prompt is provided by the user.

Accordingly, implementations described herein provide at least one technical solution to these technical problems by executing a generative model on a local device to reduce model latency. As part of executing the generative model on the local device, implementations may further reduce latency by preconfiguring the model with the context of a resource in preparation for answering a prompt about the resource. More specifically, implementation tokenizes and loads a resource's (e.g., a webpage's) content into the model as a series of portions (e.g., a set of tokens representing a portion of content). In some implementations, the system loads resource content to the model while the resource loads and/or while the user enters the prompt. This preloading of content creates an internal state, or context, for a prompt that is related to the content. In some implementations, a model provides a response based on the internal state when the prompt is received. In some implementations, the state can be saved (i.e., stored to memory) and reloaded when, for example, the resource is revisited. Because processing the content consumes significant computing resources, this preprocessing of the page content decreases the wait time between when a response is requested via a prompt and when the response is provided to the user. Moreover, when provided two prompts with matching prefix, the system avoids processing the shared prefix instead of reprocessing each prompt, which improves latency and computing resources utilization.

In some implementations, the system is configured to provide a locally executing generative model (also referred to herein as a base model) a set of tokens from a portion(s) of a resource (e.g., a webpage or document) as the resource is loaded instead of providing the resource's entire content at once. In one example, the system first normalizes a resource's content, which is then mapped to tokens in a vocabulary. Normalizing content includes cleaning and standardizing text data by performing operations like lowercasing, removing punctuation, and handling special characters, before splitting the content into tokens that are directly mapped to the vocabulary that the model is trained to understand. Put another way, normalizing content prepares the text to be processed by the model by ensuring consistency in how words are represented. A token is roughly equivalent to, for example, an English word based on the specific task for which a generative model has been trained. In some cases, the vocabulary is associated with the base model and/or a Low-Rank Adaptation (LoRA) model. LoRA models are used to fine tune a base model and may be swapped to perform a particular task while still using the same base model.

In some cases, for a particular task, a state for the model (e.g., the base model or LoRA model) is created based on the set of tokens. For example, a model may be configured to use a resource's content as context for a prompt provided by a user. The content is tokenized before the user provides the prompt (e.g., as the resource loads and the contents are displayed to the user). The tokens are provided to the model in sets (e.g., 100, 500, 1000, 2000, 3000, 5000, 10,000 or more tokens at a time). The model stores the sets of tokens in, for example, key-value (KV) cache. The model creates and then updates a state as it receives the sets of tokens. The model continues to process the sets of tokens from the content until the prompt is received or until all the information from the page is processed. In some cases, the tokens are provided to the model according to their relevance to the particular task at hand. In some cases, the model state may be stored to disk and restored when the page or task is revisited.

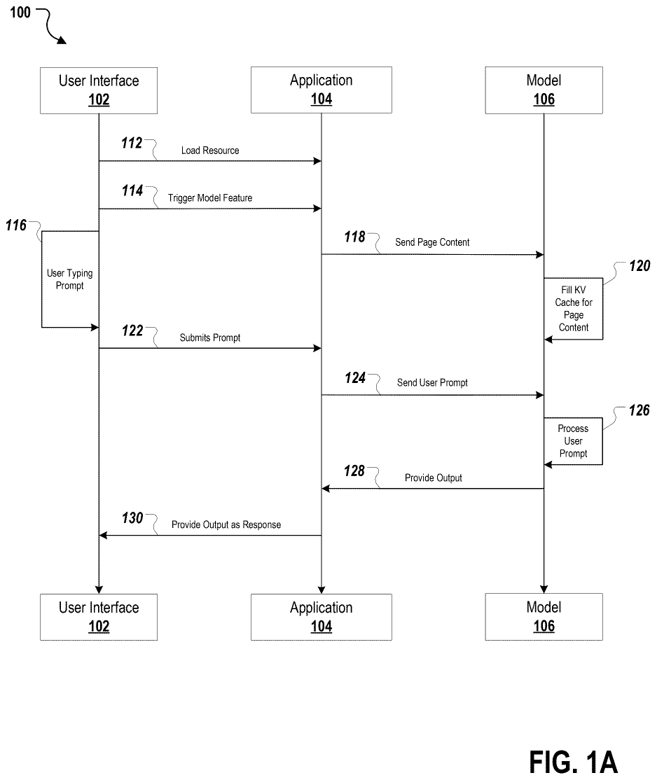

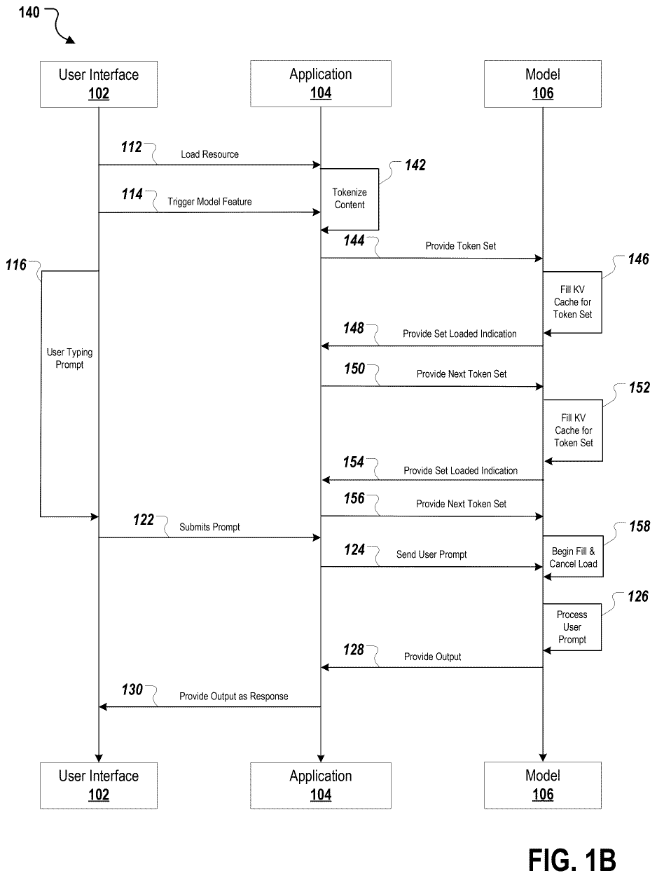

FIG. 1A depicts an example system 100 for background context processing based on content provided via a resource to reduce model latency. The example system includes a user interface 102, an application 104, and a generative model 106. The user interface 102 allows a user to interact with the application 104. In some cases, the user interface 102 is a graphical user interface (GUI) that allows users to interact with the application through graphical icons and visual indicators such as secondary notation.

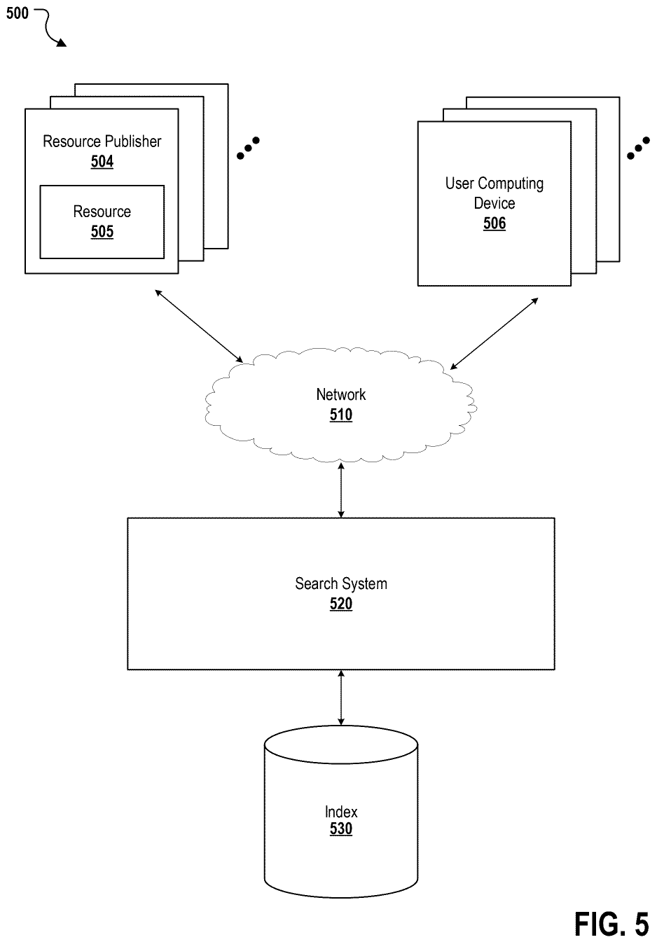

In some cases, the application 104 is a software program that allows users to perform specific tasks. For example, the application 104 is programmed to receive information provided by a user via the user interface 102 and provides responses to the user via the user interface 102. In some cases, the application 104 is a browser application that is configured to communicate with a search system, such as search system 520 described below with reference to FIG. 5. In the examples provided below, implementations are described using a browser application; however, it is contemplated that the systems and methods described herein can be used with any type of application employing a generative model to process content and provide response to prompts based on a context determined from the content.

The application 104 provides content, e.g., content provided by a web resource, to the generative model 106, which is then employed to answer prompts provided via the user interface 102 based on a context determined from the content. A generative model is a type of artificial intelligence that can create new content, such as text, images, or audio, by learning patterns from training data, e.g., a large dataset, and generating outputs that are similar to the training data thus allowing the model to produce original content based on acquire information. Put another way, a generative model is trained to generate new information that shares characteristics with the training data, rather than simply classifying existing data. Moreover, although illustrated as a single model, one or more of the generative models can be combined into the single generative model 106.

In some cases, the generative model 106 is built using a foundational model, a model that is trained on vast datasets to be applied across a wide range of use cases and trained using a combination of prompting or supervised fine tuning (SFT) to improve models for their assigned use case or function within the overall generative model. For example, the generative model 106 may be provided prompting that teaches about tools that can be used to obtain additional information about a context built from content provided by an online resource they most frequent and preferences as set by a user, e.g., via the application 104, or determined based on the user's interaction with the application 104. In some cases, synthetic training data sets may be generated to improve how the generative model 106 formulates a response to a prompt based on the set context.

In some implementations, the generative model 106 is fine-turned via Low-Rank Adaptation (LoRA), which is a lightweight training technique that reduces the number of trainable parameters. In some implementations, the LoRA training of the generative model includes inserting a smaller number of new weights into the generative model and only training these new weights. To state another way, LoRA is an improved finetuning training technique where, instead of finetuning all the weights that constitute the weight matrix of the generative model, a smaller number of matrices (e.g., two) that approximate this larger matrix are fine-tuned. These matrices constitute a LoRA adapter, which is loaded to the generative model and used for inference. Accordingly, training the generative model with LoRA is faster, more memory-efficient, and produces smaller model weights, e.g., tens to hundreds of megabytes.

As depicted, a user first provides a command to the application 104 via the user interface 102 to load a resource (step 112). For example, a user may provide a uniform resource location (URL) of a particular webpage via a GUI of a browser application. The user then triggers (step 114) a model feature via the user interface 102. For example, a user may open a panel or plugin via the user interface 102 for providing a prompt or some other interaction with the generative model 106.

Generally, when processing a prompt provided by the user interface 102, the most expensive, e.g., consumes the most significant amount of system resources such as processing time or memory, step to process is the resource's contents. However, the resource's content can be determined before the prompt is provided by the user interface allowing the application 104 to begin processing the prompt before the user begins entering the prompt, which hides much of the context processing time from the user as entering a prompt can take several seconds. Accordingly, in some implementations, the example system 100 splits the processing of a prompt into two sections where, while the user is entering (e.g., typing,) a prompt (step 116) via the user interface 102, the application 104 provides (step 118) the resource's content to the generative model 106. As the user continues to enter the prompt, the generative model 106 generates a context (i.e., an internal state) based on the content (e.g., tokens generated from the content according to a vocabulary) and stores (step 120) the context to associated cache, such a KV cache.

The user submits (step 122) the prompt to the application 104 via the user interface 102. The application 104 provides (step 124) the prompt to the generative model 106 as input. The generative model 106 processes (step 126) the prompt. Based on the context stored to the KV caches, the generative model 106 provides (step 128) an output for the prompt to the application 104. The application 104 then provides (step 130) the output to the user interface 102 as a response to the prompt. In some cases, the user interface 102 is configured to display the response via the panel or plugin when the user provides the prompt. In some cases, the user interface 102 is configured to provide an alert or message based on the response.

FIG. 1B depicts another example system 140 for background context processing based on content provided via a resource to reduce model latency. The example system 140 is similar to the example system 100 described above with reference to FIG. 1A but with additional memory loading optimization using a dynamic context size. The example system 140 capitalizes on the fact that a complete context, as determined from a resource's content, may not be necessary in order for a generative model to provide a high-quality response to a prompt. Accordingly, the example system 140 is configured to process and load as much context as possible while the user enters (step 116) the prompt.

As depicted, the example system 140 includes the user interface 102, the application 104, and the generative model 106. Similar to the system 100, the user first provides a command to the application 104 via the user interface 102 to load a resource (step 112). Content provided by the resource is tokenized (step 142). In some cases, the set of tokens are ordered according to their relevance to the particular task model feature provided at step 114. In some cases, the sets of tokens are ordered according to the structure of the respective content. For example, how the tokens are presented in the content.

After the user triggers (step 114) the model feature via the user interface 102 and while the user is entering a prompt (step 116) via the user interface 102, the application 104 provides the resource's content to the generative model 106 in sets of tokens. In some cases, the number of tokens in each portion is determined based on a system configuration, cache size, model configuration (e.g. what size it processes most efficiently), feature requirements, tradeoffs between cancellation and processing speed, and the like. The application 104 submits (step 144) the first set of tokens based on a portion of content to the generative model 106. The generative model 106 generates a context (i.e., an internal state) for the content based on the set of tokens and stores (step 146) the state from the set of tokens to KV cache. The generative model 106 provides (step 148) an indication to the application 104 that the set of tokens has been processed and loaded.

Based on receiving the indication, the application 104 is configured to provide (step 150) the next set of tokens from the next portion of content. The generative model 106 updates the state based on the next set of tokens and stores (step 152) the updated state to KV cache, which updates the context. The generative model 106 provides (step 154) an indication to the application 104 that the next set of tokens has been loaded to cache. In some cases, steps 150, 152, and 154 are repeated until the prompt is provided by the user interface or all sets of tokens are loaded by the generative model 106.

Steps 156 and 158 represent the scenario when the application provides (step 156) the generative model 106 a set of tokens from a portion of the content. While the generative model 106 is updating the context based on the set of tokens and stored in the updated context to KV cache, the user submits (step 122) the prompt to the application 104 via the user interface 102 and the application 104 provides (step 124) the prompt to the generative model 106 as input. In some implementations, when the generative model 106 receives the prompt, the generative model 106 cancels updating the context (step 158) based on the set of tokens to the KV cache and starts processing (step 126) the received prompt. In some implementations, when the generative model 106 receives the prompt, the generative model 106 completes the update and storing of the context based on the set of tokens provided to the KV cache before processing (step 126) the received prompt.

In some implementations, when all of the set of tokens are loaded by the generative model 106 but before the user has fully entered the prompt, the application 104 may be configured to receive a portion of the prompt that has been entered by the user via the user interface 102. For example, in some implementations, the user interface 102 is configured to provide the application 104 a portion of the prompt at a step time interval or based on a number of characters/tokens entered. In some implementations, the application 104 may be configured to provide a request to the user interface 102 for the portion of the prompt that has been entered by the user once all of the sets of tokens have been provided to the generative model 106.

The system 140 then proceed similarly to the system 100 where, based on the context stored to the KV caches, the generative model 106 provides (step 128) an output for the prompt to the application 104, and the application 104 provides (step 130) the output to the user interface 102 as a response to the prompt.

In some implementations, the application 104 and/or the generative model 106 may store the content of the KV cache (e.g., to longer term memory such as disk memory) once a response has been provided and/or when a content from a new resource is loaded. In some implementations, the application 104 and/or the generative model 106 is configured to load KV cache with previously stored data when a content that was previously loaded to the generative model 106 is accessed. In some cases, the previously stored data may be loaded based on both the content and the triggered model feature.

One of the primary bottlenecks with interacting with a generative model, such as generative model 106, is processing an input context. The issue worsens as the number of tokens used to build the context increases. In an example use case, the user may trigger a “Help me write” feature via the user interface 102. In such an example, the user may need to rewrite/edit the user generated portion of the prompt provided multiple times to obtain the result for which they are seeking. For example, a user writing a restaurant review may include the steps of 1) loading the restaurant's website (i.e., the resource's content) via the user interface 102 of a browser application 104, 2) triggering the “Help me write” feature provided by the browser application 104, 3) entering and submitting “the food was good” to the browser application via the user interface 102, 4) receiving a first response from the generative model 106 via the user interface 102, 5) submitting an edited second prompt of “the burritos were good, good salsa”, 6) receiving a second response from the generative model 106 via the user interface 102, 7) submitting an edited third prompt of “the burritos were good, good salsa, music was excellent”; 8) receiving a second response from the generative model 106 via the user interface 102; and 9) submitting the response as the review to the restaurant's website via the browser application 104.

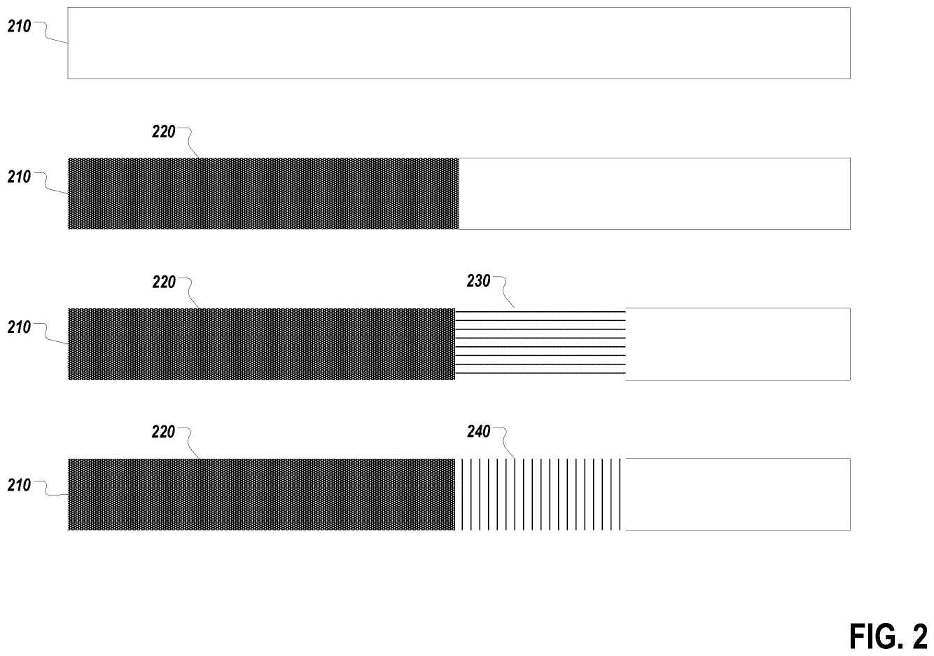

In this example, generative model 106 may have to re-process the content (i.e., regenerate the context) for the prompts submitted in steps 3), 5), and 7) unless optimization is performed via the prompt prefix caching, which is depicted in FIG. 2. Prompt prefix caching allows the generative model 106 to save a portion of a provided prompt (represented by block 220) in a cache block (represented by block 210) and re-process just the variable piece of the prompt. Only the portion shown in block 230 is processed for a first prompt (e.g., step 5) while only the portion shown in block 240 is processed for a second prompt (e.g., step 7).

This allows the browser application 104 to respond with low latency to multiple user prompts, even if they are built on top of thousands of tokens. In addition, a new feature may be triggered that is not built on top of a context of the previous feature. As described above, the KV cache for the context may be stored and later restored when the previous feature and/or content is reloaded via the browser application 104.

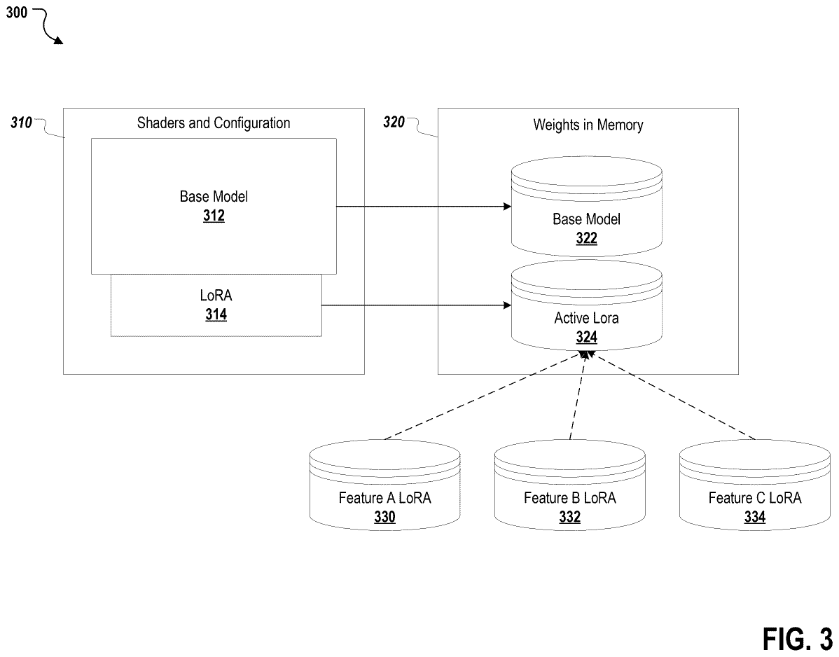

FIG. 3 depicts an example of a system 300 for dynamically swapping a LoRA in the generative model 106. The example system 300 allows for minimal overhead when loading/switching between different features and most importantly avoids reloading the model entirely. As described above, LoRA is a method of fine tuning a generative base model (e.g., generative model 106) with a relatively small set of additional weights to increase model quality for a specific task. In some cases, dynamically swapping a LoRA model includes replacing the LoRA layers at runtime, without requiring a full retraining of the base model. In some implementations, the application 104 may employ a single base model as the generative model 106, and each feature will provide a set of LoRA weights to fine tune the model for the required task. To avoid re-loading the generative model each time a new set of LoRA weights is needed, the application 104 can dynamically swap the LoRA weights out of, for example, memory.

As depicted, the shaders and configurations 310 include programs, e.g., graphical processing unit (GPU) shaders, and configuration for the base model 312 and the LoRA models 314, which are loaded into memory 320. The shaders and configuration are employed by the base model 322 and active LoRA model 324 to process the weights once the respective models 322 and 324 are loaded into memory 320. In some cases, these weights are binary data and the shaders and configuration describe how the respective models are to process the weights. As depicted, a LoRA model 330, 332, and 334 is configured for each provided feature, i.e., a selectable task, and include a set of weights to be processed by the same respective shaders and configuration. Three LoRA models are shown in FIG. 3 for simplicity; however, any number of LoRA models may be employed by the described system according to the number and/or type of features the system is configured to provide. In some implementations, when only the base model 322 is required for a task, the system is configured to skip loading and running one of the LoRA models 330, 332, or 334 as the active LoRA model 324 in memory 320.

In some implementations, the base model 322 is a generative model trained on a general corpus. Each LoRA model 330, 332, and 334 includes low-rank matrices (smaller trainable layers) that are included in specific parts of the model, typically between weights of the pre-trained layers. These matrices modify the behavior of the model without altering the original weights. In some implementations, the LoRA models 330, 332, and 334 are created during a training or fine-tuning phase based on the number and/or type of features the system is configured to provide. As depicted in FIG. 3, at runtime, the active LoRA model 324 is swapped with one of the LoRA models 330, 332, and 334 depending on the task that is selected by the user. Put another way, the low-rank matrices for the active LoRA model 324 are swapped or replaced entirely with the LoRA models 330, 332, and 334, while the base model 322 weights remain intact.

By employing the LoRA adaptation depicted in FIG. 3, a small number of parameters are introduced compared to swapping a full model. The swap operation is fast and efficient to ensure minimal downtime or performance loss. Moreover, keeping the base model 322 loaded in memory while the LoRA models 330, 332, and 334 are loaded and unloaded dynamically as needed, into active LoRA model 324, lower the memory footprint, i.e., decreasing memory usage and storage, while still adapting the generative model 106 based on the task selected. The LoRA adaptation also allows for faster adaptation and implementation of the describe system to different domains and/or tasks. As for each new task, a LoRA layer/model can be fine-tuned and/or swapped. The LoRA adaptation ensures that the generative model performs more optimally for various tasks without the entire model needing to be retrained.

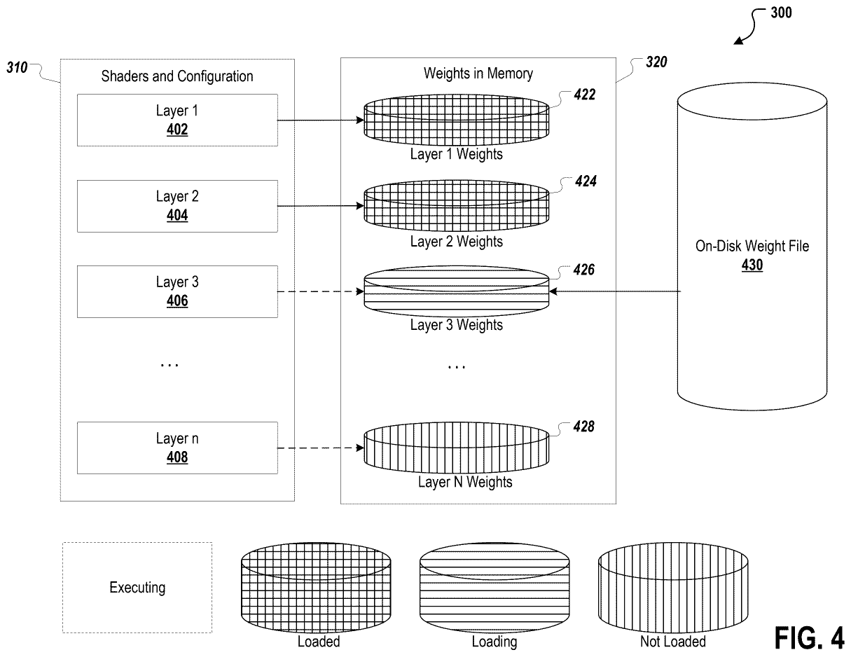

FIG. 4 depicts an embodiment of the example system 300 for parallel weight loading of a generative model, such as generative model 106. One of the most expensive elements of loading a generative model is reading the weights off disk and uploading them to memory 320. In some cases, a generative model includes many layers, represented by layers 402, 404, 406, and 408 in FIG. 4, which must be executed sequentially.

In some cases, each layer 402, 404, 406, and 408 has a different weight 422, 424, 426, and 428 respectively, that is used during processing. To speed up initialization of the generative model 106, in some implementations, the application 104 is configured to load these weights on a background thread while the generative model 106 begins processing. As depicted in FIG. 4, Layer 1 402 has completed execution, Layer 2 404 is currently executing, and Layer 3 406 is being loaded from disk 430 in parallel.

Implementations that employ the system 300 allow the generative model 106 to start executing the earlier layers while the later layers are still being read from disk 430 and loaded into memory 320. Implementation of the system 300 may be employed to speed up execution, especially when reading weights from disk is slow. In some cases, after the first pass through the model, the weights will then be kept in memory for future executions.

FIG. 5 is a block diagram of an example architecture 500 in which the described background context processing system is integrated with a search system. As depicted, a communications network 510 connects resource publishers 504, user computing devices 506, and a search system 520. The communications network 510 may include wireless and wired portions. In some cases, the communications network 510 is implemented using one or more existing networks, for example, a cellular network, the Internet, a land mobile radio (LMR) network, a BLUETOOTH network, a wireless local area network (for example, Wi-Fi), a wireless accessory Personal Area Network (PAN), a Machine-to-machine (M2M) network, and a telephone network. The communications network 510 may also include future developed networks. In some implementations, the communications network 510 includes the Internet, an intranet, an extranet, or an intranet and/or extranet that is in communication with the Internet. In some implementations, the communications network 510 includes a telecommunication or a data network.

In some implementations, the resource publishers 504 publish resources 505. The resources 505 include, for example, online resources such as web resources, online documents, webpages, and the like. In some cases, a resource publisher 504 is associated with a domain and hosted by one or more servers in one or more locations. In some cases, these one or more servers include a server-class hardware type device and/or computer systems using clustered computers and components to function as a single pool of seamless resources when accessed through the communications network 510. For example, such implementations may be used in data center, cloud computing, storage area network (SAN), and network attached storage (NAS) applications. In some implementations, the one or more servers are deployed using a virtual machine(s).

In some cases, the resource publishers 504 publish the resources 505 via a website. Such a website may include a collection of online resources 505. An online resource may include data that can be provided over the communications network 510 via a resource address, e.g., a uniform resource locator (URL). In some cases, the online resources 505 are formatted in a markup language, e.g., hypertext markup language (HTML), extensible markup language (XML), and the like. Online resources 505 may include, for example, text, images, multimedia content, programming elements, and the like. Other example online resources include, but are not limited to, images files, video files, audio files, feed sources, and the like. In some cases, the online resources 505 include embedded information such as metadata information; hyperlinks; embedded instructions, e.g., scripts; and the like.

In some implementations, the search system 520 accesses an index 530 to search resources 505. In some implementations, the index 530 includes a datastore of resources 505 generated by crawling the information, e.g., websites, provided by the resource publisher 504. In some implementations, the index 530 is a repository for persistently storing and managing collections of data. Example data stores, such as the index 530, that may be employed within the described system include data repositories, such as a database as well as simpler store types, such as files, emails, and so forth. In some implementations, the search index 530 includes a database. In some implementations, a database is a series of bytes or an organized collection of data that is managed by a database management system (DBMS).

In some implementations, user computing device(s) 506 is an electronic device capable of requesting and receiving resources over the communications network 510. Example user computing devices 506 include personal computers, mobile communication devices, tablet computers, Extended Reality (XR) devices, and the like. The user computing devices 506 may include, e.g., may each include, any appropriate type of computing device, such as a desktop computer, a laptop computer, a handheld computer, a tablet computer, a personal digital assistant (PDA), an augmented reality (AR)/virtual reality (VR) device, a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

In some implementations, the user computing devices 506 are configured to submit a prompt via a user interface and/or the application 104, to the search system 520, e.g., using a web service provided by the search system 520. In some implementations, the generative model 106 described above with reference to FIGS. 1A and 1B, is executed on the user computing devices 506. In some implementations, the generative model 106 is executed as a service provided by the search system 520. In some implementations, in response to each prompt, the search system 520 is configured to identify resources that are relevant to the query from the information stored in the index 530. For example, the search system 520 may, for example, identify the resources 505 in the form of search results. Once generated, the search results are provided as part of a search result page to the user device 506 from which the query was received.

A resource search result is data generated by the search system 520 that identifies a resource and provides information that satisfies a particular search query. A resource search result for a resource can include a webpage title, a snippet of text extracted from the resource, and a resource locator for the resource, e.g., the URL.

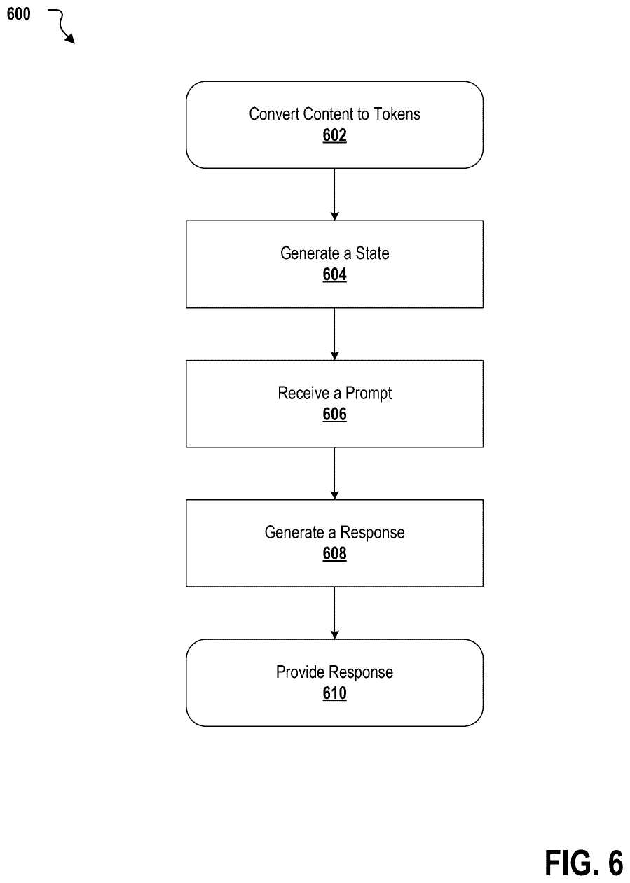

FIG. 6 depicts a flowchart of an example process 600 that can be implemented by implementations of the present disclosure. The example process 600 can be implemented by systems and components described with reference to FIGS. 1-5. The example process 600 generally shows in more detail how a response is generated by processing the prompt through a generative model having a state based on tokens generated from content provided by a resource.

For clarity of presentation, the description that follows generally describes the example process 600 in the context of FIGS. 1-5 and 7. However, it will be understood that the process 600 may be performed, for example, by any other suitable system, environment, software, and hardware, or a combination of systems, environments, software, and hardware as appropriate. In some implementations, various operations of the process 600 can be run in parallel, in combination, in loops, or in any order.

At 602, content from a resource is converted to tokens. For example, a user provides, via the user interface 102, a location, e.g., a URL, of a resource. In some implementations, content from the resource is converted to tokens by the application 104 based on a vocabulary associated with a task selected by the user via the user interface 102 and/or a LoRA model associated with the selected task. In some implementations, information represented by the tokens represents information represented by the content. In some implementations, the content is converted to the tokens based on a vocabulary associated with the task selected via the user interface. In some implementations, the information represented by the tokens represent the content. In some implementations, the vocabulary is independent from a language of the content.

From 602, the process 600 proceeds to 604 where a state for the generative model 106 is generated by processing the tokens through the generative model 106 based on the state. In some implementations, generating the state includes portioning the tokens into sets of tokens, determining an order for the sets of tokens according to the relevance of the tokens to the selected task. Put another way, each set of tokens may have a respective relevance metric calculated, the relevance metric reflecting the relevance of the tokens in the set with the selected task. Once respective relevance metrics are calculated, the state is generated by processing the sets of tokens through the generative model according to the order. This can continue until the prompt is received (e.g., by the user interface), The processing of the sets of tokens according to the order can continue until all tokens in the sets of tokens are stored. In some implementations, a set of tokens from the sets of tokens includes a defined number of tokens. The defined number of tokens determined can be based on a size of a cache associated with the generative model. The defined number of tokens can be based on how the generative model is trained and/or configured. The defined number of tokens can be based on a feature requirement associated with the generative model or the selected task. The defined number of tokens can be based on a tradeoff between a desired cancellation speed and processing speed for the generative model. The defined number of tokens can be an implementation parameter based on any combination of the above.

In some implementations, generating the state includes processing a set of tokens of the sets of tokens through the generative model 106 to generate an updated state. In some implementations, the updated state is stored as the state to a cache associated with the generative model 106. In some implementations, the updated state provides context to the generative model 106 for the selected task according to the sets of tokens processed by the generative model 106.

From 604, the process 600 proceeds to 606 where a prompt is received from the user interface 102. In some implementations, receiving the prompt includes receiving a portion of the prompt from the user interface. In some implementations, the portion of the prompt is provided to the generative model 106 for preprocessing (e.g., processing the portion of the prompt through the model to, for example, update the state).

From 606, the process 600 proceeds to 608 the prompt is processed through the generative model 106 to generate a response. In some implementations, the generative model is associated with the task and the vocabulary by using an adaptation model (e.g., a LoRA model) to adjust a set of weights of the generative model. In some implementations, the adaptation model is swapped in memory based on the selected task. In some implementations, the response is generated using the adaptation model. In some implementations, swapping to the adaptation model includes loading a GPU shader associated with the LoRA model to process a set of weights associated with the adaptation model.

In some implementations, the generative model 106 includes a first layer associated with a first set of weights and a second layer associated with a second set of weights. In some implementations, processing the prompt through the generative model 106 to generate the response includes: loading the first set of weights to a first memory location associated with the first layer; processing the prompt through the first layer; in parallel to processing the prompt through the first layer, loading the second set of weights to a second memory location associated with the second layer; and processing the prompt through the second layer.

From 608, the process 600 proceeds to 610 where the response is provided to the user interface 102 via the application 104. In some implementations, the state is stored to a memory. In some implementations, in response to receiving a request from the user interface 102 to reload the resource, the state is related from the memory to a cache. In some implementations, the prompt is a first prompt and the response is a first response. In some implementations, a second prompt is received from the user interface 102 and a second response is provided to the user interface. In some implementations, the second response is determined by processing the second prompt through the generative model 106 using the state. From 610, the process 600 ends or repeats.

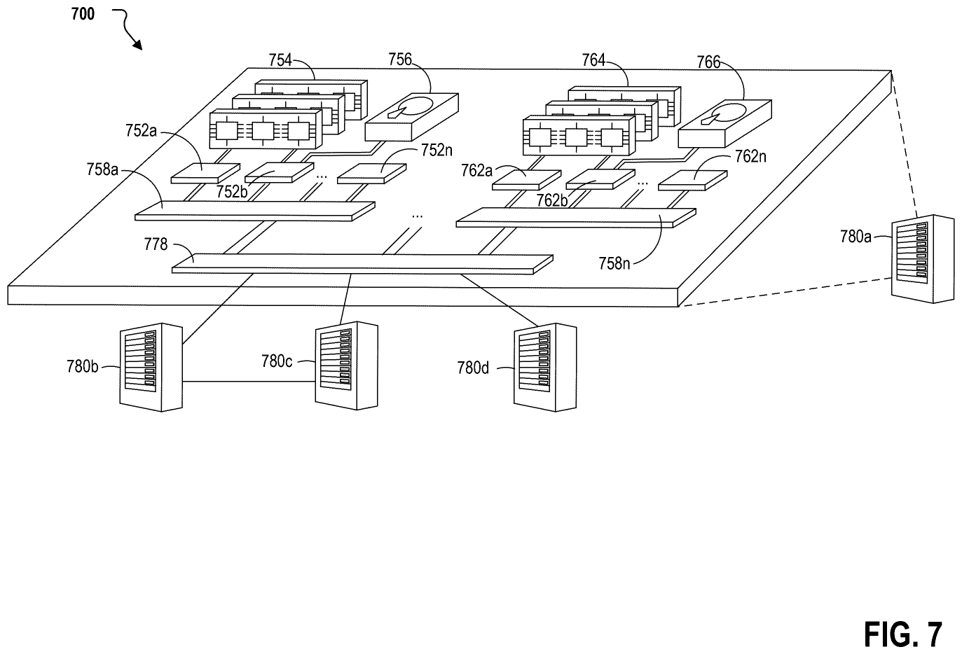

FIG. 7 shows an example of a computing device 700, which may be search system 520 of FIG. 4, which may be used with the techniques described here. The example computing device 700 can be programmed or otherwise configured to implement systems or methods of the present disclosure. Computing device 700 is intended to represent various example forms of large-scale data processing devices, such as servers, blade servers, data centers, mainframes, and other large-scale computing devices. Computing device 700 may be a distributed system having multiple processors, possibly including network attached storage nodes, that are interconnected by one or more communications networks. The components shown here, their connections and relationships, and their functions, are meant to be examples only, and are not meant to limit implementations of the implementations described and/or claimed in this document.

Computing device 700 may be a distributed system that includes any number of computing devices 780, e.g., 780a, 780b, . . . 780n. Computing devices 780 may include a server or rack servers, mainframes, and the like, communicating over a local or wide-area network, dedicated optical links, modems, bridges, routers, switches, wired or wireless networks, and the like.

In some implementations, each computing device may include multiple racks. For example, the computing device 780a includes multiple racks, e.g., 758a, 758b, . . . , 758n. Each rack may include one or more processors, such as processors 752a, 752b, . . . , 752n and 762a, 762b, . . . , 762n. The processors may include data processors, network attached storage devices, and other computer-controlled devices. In some implementations, one processor may operate as a master processor and control the scheduling and data distribution tasks. Processors may be interconnected through one or more rack switches 762a-762n, and one or more racks may be connected through switch 778. Switch 778 may handle communications between multiple connected computing devices 700.

Each rack may include memory, such as memory 754 and memory 764, and storage, such as 756 and 766. Storage 756 and 766 may provide mass storage and may include volatile or non-volatile storage, such as network-attached disks, floppy disks, hard disks, optical disks, tapes, flash memory or other similar solid state memory devices, or an array of devices, including devices in a storage area network or other configurations. Storage 756 or 766 may be shared between multiple processors, multiple racks, or multiple computing devices and may include a non-transitory computer-readable medium storing instructions executable by one or more of the processors. Memory 754 and 764 may include, e.g., volatile memory unit or units, a non-volatile memory unit or units, and/or other forms of non-transitory computer-readable media, such as a magnetic or optical disks, flash memory, cache, Random Access Memory (RAM), Read Only Memory (ROM), and combinations thereof. Memory, such as memory 754 may also be shared between processors 752a-752n. Data structures, such as an index, may be stored, for example, across storage 756 and memory 754. Computing device 700 may include other components not shown, such as controllers, buses, input/output devices, communications modules, and the like.

An entire system may be made up of multiple computing devices 700 communicating with each other. For example, device 780a may communicate with devices 780b, 780c, and 780d, and these may collectively be known as a search system, such as the search system 520 described above with reference to FIG. 5. Some of the computing devices may be located geographically close to each other, and others may be located geographically distant. The layout of computing device 700 is an example only and the system may take on other layouts or configurations.

It should also be understood that although certain drawings illustrate hardware and software located within particular devices, these depictions are for illustrative purposes only. In some implementations, the illustrated components may be combined or divided into separate software, firmware, or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Moreover, various implementations of the systems and techniques described herein can be realized in digital electronic circuitry, integrated circuitry, specially designed ASICs (application specific integrated circuits), computer hardware, firmware, software, or combinations thereof. These various implementations can include implementation in one or more computer programs that are executable or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include computer readable or machine instructions for a programmable electronic processor and can be implemented in a high-level procedural or object-oriented programming language, or in assembly/machine language. As used herein, the terms “machine-readable medium” and “computer-readable medium” refers to any computer program product, apparatus or device, e.g., magnetic discs, optical disks, memory, Programmable Logic Devices (PLDs), used to provide machine instructions or data to a programmable processor, including a machine-readable medium that receives machine instructions as a machine-readable signal. The term “machine-readable signal” refers to any signal used to provide machine instructions or data to a programmable processor.

The functionality of the computer readable instructions may be combined or distributed as desired in various environments. In some implementations, a computer program includes one sequence of instructions. In some implementations, a computer program includes a plurality of sequences of instructions. In some implementations, a computer program is provided from one location. In other implementations, a computer program is provided from a plurality of locations. In various implementations, a computer program includes one or more software modules. In various implementations, a computer program includes, in part or in whole, one or more web applications, one or more mobile applications, one or more standalone applications, one or more web browser plug-ins, extensions, add-ins, or add-ons, or combinations thereof.

Further to the descriptions above, a user may be provided with controls allowing the user to make an election as to both if and when systems, programs, or features described herein may enable collection of user information, e.g., information about a user's social network, social actions, or activities, profession, a user's preferences, or a user's current location, and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained, such as to a city, ZIP code, or state level, so that a particular location of a user cannot be determined. Thus, the user may have control over what information is collected about the user, how that information is used, and what information is provided to the user.

Unless otherwise defined, the technical terms used herein have the same meaning as commonly understood by one of ordinary skill in the art to which the present subject matter belongs. As used in this specification and the appended claims, the singular forms “a,” “an,” and “the” include plural references unless the context clearly dictates otherwise. Any reference to “or” herein is intended to encompass “and/or” unless otherwise stated.

A number of implementations have been described. Nevertheless, it will be understood that various modifications may be made without departing from the spirit and scope of the disclosed implementations. While preferred implementations of the present disclosure have been shown and described herein, it will be obvious to those skilled in the art that such implementations are provided by way of example only. Numerous variations, changes, and substitutions will now occur to those skilled in the art without departing from the described system. It should be understood that various alternatives to the implementations described herein may be employed in practicing the described system.

Moreover, the separation or integration of various system modules and components in the implementations described earlier should not be understood as requiring such separation or integration in all implementations, and it should be understood that the described components and systems can generally be integrated together in a single product or packaged into multiple products. Accordingly, the earlier description of example implementations does not define or constrain this disclosure. Other changes, substitutions, and alterations are also possible without departing from the spirit and scope of this disclosure.

What is claimed is:

1. A method comprising:
converting content from a resource to tokens;
generating a state for a generative model by processing the tokens through the generative model;
receiving a prompt from a user interface;
processing the prompt through the generative model to generate a response based on the state; and
providing the response to the user interface.

2. The method of claim 1, wherein generating the state includes:
portioning the tokens into sets of tokens;
determining an order for the sets of tokens according to a relevance metric; and
generating the state by processing the sets of tokens through the generative model according to the order until the prompt is received or until the sets of tokens are stored.

3. The method of claim 2, wherein processing a set of tokens of the sets of tokens through the generative model generates an updated state, and generating the state includes:
storing the updated state as the state to a cache associated with the generative model, wherein the updated state provides context to the generative model for a task that represents the sets of tokens processed by the generative model.

4. The method of claim 2, wherein a set of tokens of the sets of tokens includes a defined number of tokens, the defined number of tokens determined based on a size of a cache associated with the generative model, a configuration of the generative model, a feature requirement associated with the generative model or a task provided via the user interface, or a cancellation speed requirement associated with the generative model.

5. The method of claim 1, wherein receiving the prompt includes receiving a portion of the prompt from the user interface, the method further comprising:
while the prompt continues to be entered via the user interface, providing the portion of the prompt to the generative model for preprocessing.

6. The method of claim 1, wherein the content is converted to the tokens based on a vocabulary associated with a task selected via the user interface, and the generative model is associated with the task and the vocabulary by using an adaptation model to adjust a set of weights of the generative model, the method further comprising:
swapping to the adaptation model based on the task; and
generating the response via the adaptation model.

7. The method of claim 6, wherein swapping to the adaptation model includes loading a graphical processing unit shader associated with the adaptation model to process the set of weights.

8. The method of claim 1, further comprising:
storing the state to a memory;
receiving a request to reload the resource; and
reloading the state from the memory to a cache in response to receiving the request to reload the resource.

9. The method of claim 8, wherein the prompt is a first prompt and the response is a first response, the method further comprising:
receiving a second prompt from the user interface; and
providing a second response to the user interface, the second response determined by processing the second prompt through the generative model using the reloaded state.

10. The method of claim 1, wherein the content is converted to the tokens based on a vocabulary associated with a task selected via the user interface, and the vocabulary is independent from a language of the content.

11. The method of claim 1, wherein the generative model includes a first layer associated with a first set of weights and a second layer associated with a second set of weights, and processing the prompt through the generative model to generate the response includes:
loading the first set of weights to a first memory location associated with the first layer;
processing the prompt through the first layer;
in parallel to processing the prompt through the first layer, loading the second set of weights to a second memory location associated with the second layer; and
processing the prompt through the second layer.

12. A non-transitory computer-readable medium storing executable instructions that when executed an electronic processor, cause the electronic processor to:
convert content from a resource to tokens;
generate a state for a generative model by processing the tokens through the generative model;
receive a prompt from a user interface;
process the prompt through the generative model to generate a response based on the state; and
provide the response to the user interface.

13. The non-transitory computer-readable medium of claim 12, wherein the executable instructions further cause the electronic processor to:
receive a portion of the prompt from the user interface; and
provide the portion of the prompt to the generative model for preprocessing.

14. The non-transitory computer-readable medium of claim 12, wherein the content is converted to the tokens based on a vocabulary associated with a task selected via the user interface, and the generative model is associated with the task and the vocabulary by using an adaptation model to adjust a set of weights of the generative model, the executable instructions further cause the electronic processor to:
swap to the adaptation model based on the task; and
generate the response via the adaptation model.

15. The non-transitory computer-readable medium of claim 12, wherein the generative model includes a first layer associated with a first set of weights and a second layer associated with a second set of weights, and the executable instructions cause the electronic processor to process the prompt through the generative model to generate the response by:
loading the first set of weights to a first memory location associated with the first layer;
processing the prompt through the first layer;
in parallel to processing the prompt through the first layer, loading the second set of weights to a second memory location associated with the second layer; and
processing the prompt through the second layer.

16. A system comprising:
a user interface;
a generative model; and
an electronic processor communicably coupled to the user interface and configured to:
convert content from a resource to tokens based on a vocabulary associated with a task selected via the user interface;
generate a state for the generative model by processing the tokens through the generative model;
receive a prompt from the user interface;
process the prompt through the generative model to generate a response based on the state; and
provide the response to the user interface.

17. The system of claim 16, wherein the electronic processor is configured to generate the state by:
portioning the tokens into sets of tokens;
determining an order for the sets of tokens according to a relevance metric; and
generating the state by processing the sets of tokens through the generative model according to the order until the prompt is received or until the sets of tokens are stored.

18. The system of claim 17, further comprising a cache associated with the generative model, wherein processing a set of tokens of the sets of tokens through the generative model generates an updated state, and the electronic processor is further configured to generate the state by:
storing the updated state as the state to the cache associated with the generative model, wherein the updated state provides context to the generative model for the task that represents the sets of tokens processed by the generative model.

19. The system of claim 16, further comprising:
a memory,
wherein the electronic processor is further configured to:
store the state to the memory;
receive a request to reload the resource; and
reload the state from the memory to a cache in response to receiving the request to reload the resource.

20. The system of claim 19, wherein the prompt is a first prompt and the response is a first response, the electronic processor is further configured to:
receive a second prompt from the user interface; and
provide a second response to the user interface, the second response determined by processing the second prompt through the generative model using the state using the reloaded state.
